(19) United States
(12) Patent Application Publication
(10) Pub. No.: US 2016/0359631 A1
(43) Pub. Date: Dec. 8, 2016

(54) SECURE PERFECT HASH FUNCTION

(71) Applicant: Pitney Bowes Inc., Danbury, CT (US)

(72) Inventors: Yassir Nawaz, Shelton, CT (US); Femi Olumofin, Trumbull, CT (US); Shi Hao Yuan, London (CA)

(73) Assignee: Pitney Bowes Inc., Danbury, CT (US)

(21) Appl. No.: 14/733,000

(22) Filed: Jun. 8, 2015

(51) Int. Cl. H04L 9/32; H04L 29/06; G06F 17/30

(52) U.S. Cl. CPC H04L 9/3239; G06F 17/3033; H04L 63/0876

(57) ABSTRACT

A secure perfect hash function that has properties similar to those of cryptographic hash functions without compromising features of a perfect hash function such as speed and collision-free outputs is provided. A cryptographic hash function is utilized to process the set S and the. output is divided into three sub-outputs of required length. Each output can now be treated as a separate hash function (g(x), f1(x), f2(x)), S is split into r buckets Bi, 0≦i<r, using the hash function g. Buckets Bi are permuted in a pseudorandom fashion. For each bucket Bi, a displacement pair (d0, d1) is chosen randomly from the sequence {(0,0), (0,1), . . . (0, m−1), (1,,0),(1,1), . . . , (1, m−1), . . . ,(m−1, m−1)} such that each element of Bi is placed in an empty bin given by (f1(x)+d0f2(x)+d1) mod m. The index of this displacement is stored in the sequence.

### FIELD OF THE INVENTION

The present invention relates to computing functions to facilitate fast and secure lookups on large data sets.

### BACKGROUND OF THE INVENTION

Data matching is a key component in data integration and data quality. Data matching is often performed between two parties with data on common entities. The purpose of matching could be to perform checks or develop deeper insights about those entities. However, sometimes the data in question is sensitive and the parties don't want to share their datasets with each other or a third party to do the match. For example, consider two companies each with its own customer database. For a joint marketing campaign the two companies want to find which individuals are customers of both companies. An easy method to find common customers is for the companies to exchange their databases with each other or to give it to a third party for the match. However, both companies are reluctant to share their customer database with anyone due to concerns around data security and privacy. In some cases, especially if the company belongs to a regulated industry, the privacy regulations prevent the companies from sharing customer data such as PII (Personally Identifiable Information) or PHI (Protected Health Information).

Perfect Hash Functions are used in computing to facilitate fast lookups on large data sets. Perfect Hash Functions are used in applications which require compact hash outputs without collisions. One such example is the Private Information Retrieval (PIR) Protocols, such as described in Privacy Preserving Queries over Relational Databases, F. Olumofin and I. Goldberg, Lecture Notes in Computer Science, Vol. 6205, 2010, pp 75-92. Although perfect hash functions are very efficient, they are usually not suitable for security applications which require a secure hash function. On the other hand cryptographic hash functions are secure but they don't have compact outputs and are not suitable for applications which require collision-free and compact hash outputs. Therefore there is a need for perfect hash functions with compact outputs that have security properties similar to those of cryptographic hash functions. These secure perfect hash functions will help solve problems such as private, matching, such as described in U.S. patent application Ser. No. 14/543,959, the contents of which is hereby incorporated by reference in its entirety, in a more efficient manner.

### SUMMARY OF THE INVENTION

The present invention alleviates the problems described above by providing a secure perfect hash function that has properties similar to those of cryptographic has functions without compromising features of a perfect hash function such as speed and collision-free outputs.

In accordance with embodiments of the present invention, a cryptographic hash function, such as, for example, SHA-2, is utilized to process the set S and the output is divided Into three sub-outputs of required length, Each output can now be treated as a separate hash function thus giving three hash functions (g(x), f1(x), f2(x)). S is split into r buckets Bi 0≦i<r, using the hash function g. Buckets Bi are permuted in a pseudorandom fashion. For each bucket Bi, a displacement pair (d0, d1) is chosen randomly from the sequence {(0,0), (0,1), . . . , (0, m−1), (1,0), (1,1), . . . , (1, m−1), . . . , (m−1, m−1)}, such that each element of Bi is placed m an empty bin given by (f1(x)+d0f2(x)+d1) mod m. If the displacement pair is not successful, another random pair is tried until a successful displacement is found. The index of this displacement is stored in the sequence. The secure perfect hash function then consists of the data structure that stores these m indexes, This hash function has properties similar to those of cryptographic hash functions, without compromising the attractive features of perfect hash functions such as speed and compact collision free outputs.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a portion of a system that can be used to implement the present invention;

FIG. 2 is a block diagram illustrating the operation of a conventional compressed hash-and-displace (CHD) function and

FIG. 3 is a block diagram illustrating the operation of a secure perfect hash function according to an embodiment of the present invention.

### DETAILED DESCRIPTION OF THE PRESENT INVENTION

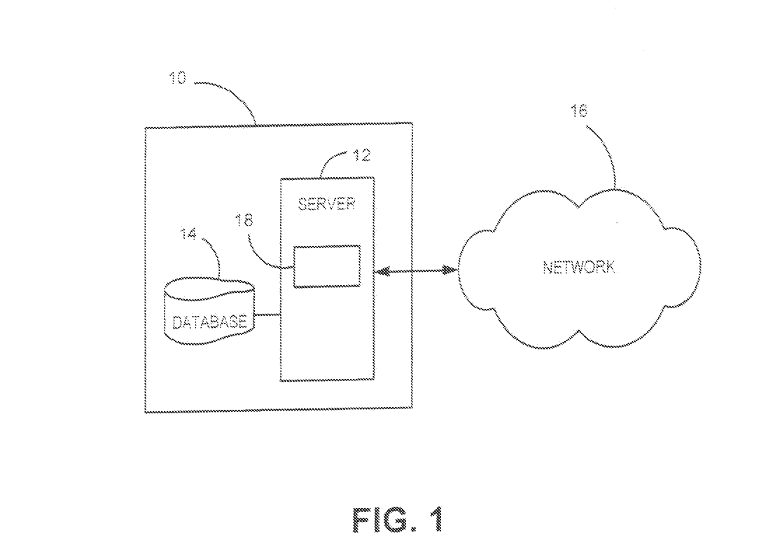

In describing the present invention, reference is made to the drawings, wherein there is seen in FIG. 1 in block diagram fern a portion of a system 10 that can be used to implement the method described herein according to embodiments of the present invention. System 10 includes a server 12, which may be operated, for example, by a business, organization, or any other type of entity. Server 12 is coupled to a database 14, which may be any suitable type of memory device utilized to store information. Server 12 may be coupled to a network 10, such us, for example the Internet, to allow communication with other servers, Server 12 may be a mainframe or the like that includes at least one processing device 18. Server 12 may be specially constructed for the required purposes, or it may comprise a general purpose computer selectively activated or below) reconfigured a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the processing device 18. One of ordinary skill in the art would be familiar with the general components of it computing system upon which the method of the present invention may be performed.

For a complete understanding of the present invention, it is necessary to understand the types of hash functions and the differences between them. A Perfect Hash Function for a set S is a hash function that maps each entry in that set to a set of integers without any collisions, i.e. no two members of the set S are mapped to the same integer by the perfect hash function. Once the perfect hash function to a set S has been created, the hash of any member of S can be evaluated in constant time. An example of a perfect hash function is the. Compressed Hash-and-Displace (CHD) function as described in Hash, Displace and Compress, D. Belazzougui, F. C. Botelho and M. Dietzfelbinge, 17^{th} Annual European Symposium, Copenhagen, Denmark, Sep. 7-9, 2009, pages 682-693. CHD (and many other perfect hash functions) is presented by a data structure which is computed from the input set S and is only valid for the input set S. If the input set changes to S a new CHD (and the associated data structure) will have to be calculated for S′.

A minimal perfect hash function is a perfect hash function that maps n elements of a set S to n consecutive integers. Minimal perfect hash functions are desirable because of their compact representation. All minimum perfect hash functions are also perfect hash functions.

There are several notable differences between Cryptographic Hash Functions and CHD. They are as follows: (i) A CHD hash function is computed from a particular input set S and is only valid for that input set. A cryptographic hash function is not computed from an input set and is therefore valid for any input. ii) A CHD hash function is represented by a data structure whose size is proportional to the size of the input set S. Cryptographic hash functions on the other hand have fixed compact representations which do not depend on the input. (iii) The output of the cryptographic hash functions doesn't leak any information about its input. The output of the CHD hash function leaks some information about its input set S. (iv) The CHD representation i.e., the associated data structure, leaks information about its input set S. Cryptographic hash function representations are not tied to a particular input set.

Traditional Perfect Hash Functions have been designed to produce compact collision-free outputs to facilitate fast lookups on large data sets. They do their job well but are not suitable for security applications which, require hash functions that don't leak information abort their input. Perfect hash functions have some desirable properties that can be used to design privacy and security protocols. For example perfect hash functions like CHD are computed from a specific input set and are only valid for that input set. This property can be used to design efficient private matching protocols which allow two panics to find the intersection of their data sets without sharing their data sets with each other. However, fur the private matching protocol to be secure it is required that the perfect hash function must not leak information about its input set S.

A more detailed description of CHD will now be provided, along with its drawbacks and new enhancements according to the present invention to make it secure fur security and privacy applications. The CHD function maps all elements of a set S to m bins such that no bin has more than one element and m≧|S| (|s| is the size of the set S). The function performs this mapping in two steps. In the first step the CHD function uses a hash function to map elements of S to an intermediate table of size r (or r buckets) where r<|S|. In the second step, for each bucket the CHD function uses independent random hash functions to map elements of that bucket to a table of size m (or m bins) such that no bin has more than one element where m≧|S|S. A more detailed description of the CHD function is as follows:
1. Split S into buckets Bi=g⁻¹({i}) ∩ S, 0≦i<r;
2. Sort buckets Bi in falling order according to size |Bi|
3. Initialize array T[0 . . . m−1] with 0's;
4. for all i ∈ [r], in the order from (2), do
5. for 1,2, . . . repeat forming Ki={φl(x)|x ∈ Bi}
6. until |Ki|=|Bi| and Ki ∩ {j|T[j]=1}=;
7. let σ(i)=the successful l;
8. for all j ∈ Ki let T|j|=1;
9.Transform (σ(i))0≦i<r into compressed form, retaining O(1) access,
where (i) g is a first level hash function that maps S into r buckets, (ii) (φ1, φ2, φ3, . . . ) is a sequence of independent fully random hash function (they make the second level hash functions), and (iii) σ(i) is the index of the random function in the sequence (φ1, φ2, φ3, . . . ) that successfully places members of bucket Bi into T without collision.

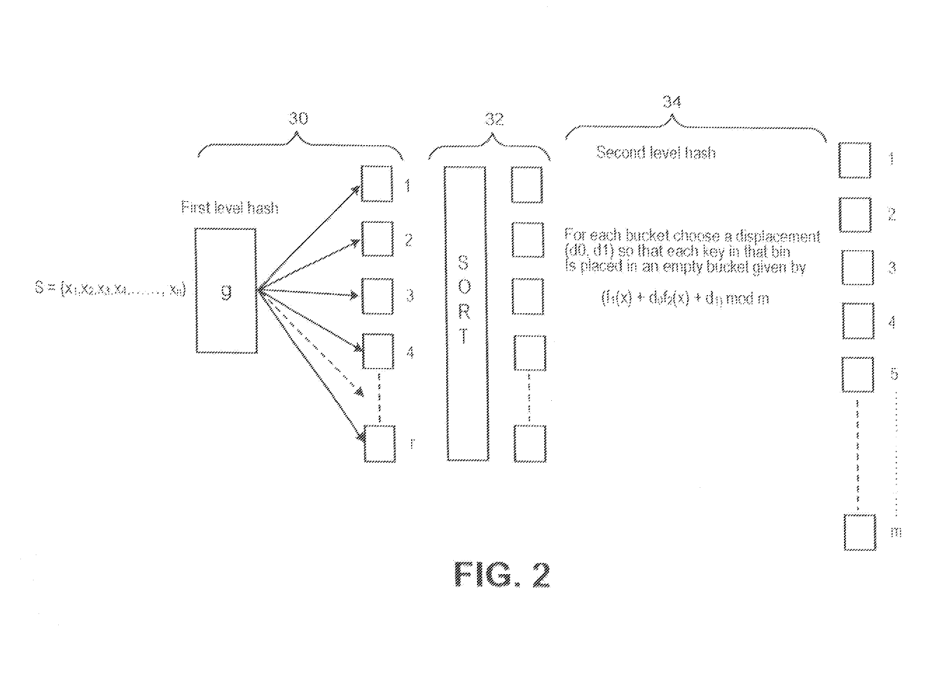

Referring now to FIG. 2, is simplified version of the above CHD function suitable for implementation is described. For this implementation a heuristic, hash function is selected for use, such as described in Algorithm Alley: Hash Functions, by Bob Jenkins, Dr. Dobb's journal of Software Tools, September 1997. The output of the Jenkins hash is 12 bytes, which is divided into 3 outputs of 4 bytes each. Each 4 byte output can now be treated as a separate hash function thus giving its 3 hash functions (g(x), f1(x), f2(x)). In step 30, the set S is split into r buckets Bi, 0≦i<r, using the hash function g. In step 32, the buckets Bi are stored in falling order according to size |Bi|. In step 34, for each bucket Bi find the first pair of displacements (d0, d1) in the sequence {(0,0), (0,1), . . . , (0, m−1), (1,0), (1,1), . . . , (1, m−1), . . . , (m−1, m−1)} such that each element of Bi is placed in an empty bin given by (f1(x)+d0f2(x)+d1) mod m. Thus, the chosen pair (d0, d1) is the first in the set {(0,0), (0,1), . . . , (0, m−1), (1,0), (1,1), . . . , (1, m−1), . . . , (m−1, m−1)} that successfully displaces every key to a unique slot in the range |m|. In step 36, the index of this displacement is stored in the sequence. The CHD hash function then consists of the data structure that stores these m indexes.

There are issues with the CHD function, however, such that the data structure of the CHD hash as well as the output of the CHD hash can leak significant information about the input. For example, consider two input sets S and S′ of same size which only differ in one element. Then according to the above function the CHD hash functions computed for the two sets S and S′ will be similar, i.e., the data structures of the two CDH hash functions will be similar. To see why first consider step 32 of FIG. 2. Since S and S′ only differ in one element all the buckets computed for S and S′ will be identical except one. Now consider step 36. Since the displacement is always selected from the sequence in a fixed and known manner, with high probability the displacements selected for most buckets will he identical for S and S′. Therefore the final CHD data structure for the input sets S and S′ will be very similar, i.e., most of the equivalent indexes stored in the two data structures will be identical. As another example, consider CHD hashes of two input sets S and S′ which have a large intersection. Then the data structures associated with the two CHD hashes will be very similar. This means that for most entries that lie in both S and S′ the output of the two CHD hashes will be same. These two issues mean that the data structure of the CHD hash as well as the output of the CHD hash leak significant information about the input. For example, if an attacker sees two similar CHD hashes he or she can conclude that they were computed from the inputs that significantly overlapped. Similarly, if the attacker had access to one of the input sets, given the output of a CHD, he or she can guess the corresponding input. This is it highly undesirable property in a security application that requires the input of the hash to remain private.

According to the present invention, modifications are made to the CHD function as illustrated in FIG. 2 to ensure that it does not teak information about its input without compromising its desirable properties. Generally, in step 30, instead of using the Jenkins hash function, a cryptographic hash function such as SHA-1 or SHA-2 is used. The output of the cryptographic hash function is usually large, i.e., 32 bytes, for SHA 2. From these 32 output bytes the required number of bytes can be selected to form three functions g(x), f1(x), and f2(x). For example, bytes 0-3 can be assigned to g(x), bytes 4-7 assigned to f1(x) and bytes 8-11 assigned to f2(x) and ignore the rest. This will ensure that these three hash functions don't leak information about their inputs. In step 32, instead of sorting buckets Bi in failing order according to size |Bi|, buckets Bi are permuted randomly using, for example, a random or pseudorandom sequence. In step 34, instead of picking the first pair of displacements (d0, d1) in the sequence {(0,0), (0,1), . . . , (0, m−1), (1,0), (1,1), . . . , (1, m−1), . . . , (m−1, m−1)} ; pick a pair of random displacement in the sequence {(0,0), (0,1), . . . , (0, m−1), (1,0), (1,1), . . . , (1, m−1), . . . , (m−1, m−1)} such that each element of Bi is placed in an empty bin given by (f1(x)+d0f2(x)+d1) mod m. Thus, the chosen pair (d0, d1) is drawn uniformly at random from the set {(0,0), (0,1), . . . , (0, m−1), (1,0), (1,1), . . . , (1, m−1), . . . , (m−1, m−1)}, and it successfully displaces every key to a unique slot m the range |m|. These modifications ensure that the CHD data structure and the output of the CHD do not leak information about its input. Note that these modifications ensure that if two sets S and S′ differ slightly, their CHD data structures and the output of the CHD hash functions will be very different. Also every time the CHD for the set S is computed, due to the random nature of the permutation and displacements the resulting data structure will be different each time with very high probability.

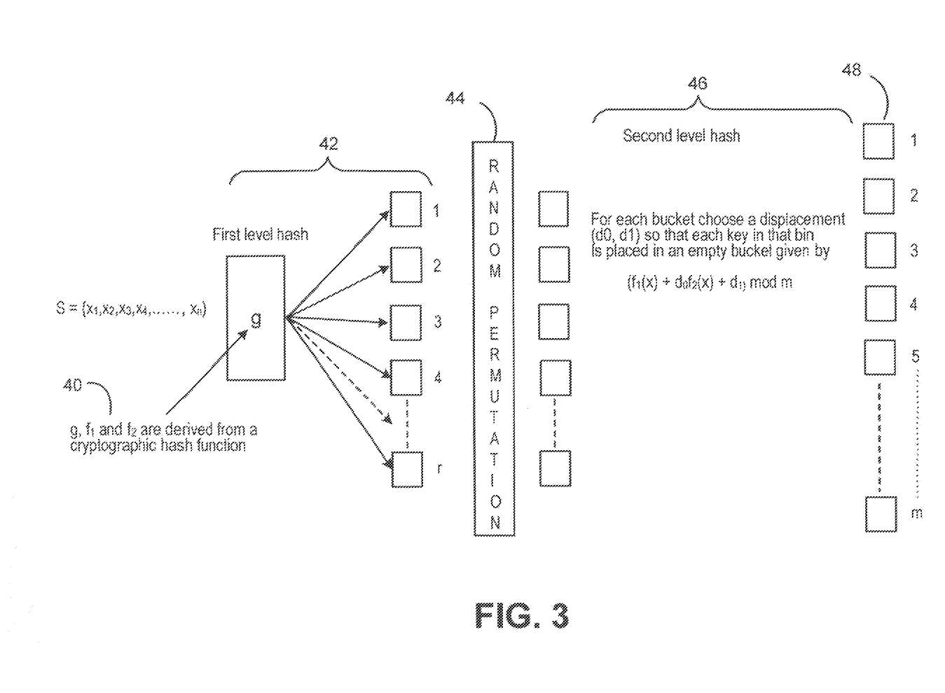

Referring now to FIG. 3, the secure CHD hash function that does not leak information about its input according to the present invention is illustrated. in step 40, set S is input to a cryptographic hash function, such as, for example, SHA-2, and the output is divided into three sub-outputs of required length. Each output can now be treated as it separate hash function thus giving three hash functions f1(x), f2(x)). In step 42, S is split into r buckets Bi, 0≦i<r, using the hash function g. In step 44, buckets Bi are permuted in a pseudorandom fashion. in step 46, for each bucket Bi, displacement pair (d0, d1) is chosen randomly from the sequence {(0,0), (0,1), . . . , (0, m−1), (1,0), (1,1), . . . , (1, m−1), . . . , (m−1, m−1)} such that each element of Bi is placed in an empty bin given by (f1(x)+d0f2(x)+d1) mod m. If the displacement pair is not successful, another displacement pair is randomly chosen until a successful displacement is found. In step 48, index of this displacement is stored in the sequence. The secure perfect hash function then consists of the data structure that stores these in indexes. This hash function has properties similar to those of cryptographic hash functions, without compromising the attractive features of perfect hash functions such us speed and compact collision free outputs.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A computer implemented method for generating a secure perfect hash function for a set S comprising:
utilizing, by a computer, a cryptographic hash function to generate an output;
dividing, by the computer, the output into three hash functions (g(x), f1(x), f2(x));
splitting, by the computer, the set S into r buckets Bi, 0≦i<r, using the hash function g(x);
permuting, by the computer, buckets Bi a pseudorandom fashion;
randomly choosing, by the computer a displacement pair (d0, d1) from a sequence {(0,0), (0,1), . . . ,(0, m−1), (1,0), (1,1), . . . , (1, m−1), . . . , (m−1, m−1)} such that each element of Bi is placed in an empty bin given by (f1(x)+d0f2(x)+d1) mod m; and
storing, by the computer, an index m of the displacement pair (d0, d1) in a sequence,
wherein the secure perfect hash function consists of the data structure that stores these m indexes.
